(19) United States
(12) Patent Application Publication
(10) Pub. No.: US 2024/0255384 A1
(43) Pub. Date: Aug. 1, 2024

(54) PLANT MONITORING DEVICE, PLANT MONITORING METHOD, AND PLANT MONITORING PROGRAM

(71) Applicant: MITSUBISHI HEAVY INDUSTRIES, LTD., Tokyo (JP)

(72) Inventors: Ichiro NAGANO, Kanagawa (JP); Mayumi SAITO, Tokyo (JP); Kuniaki AOYAMA, Tokyo (JP); Keiji EGUCHI, Tokyo (JP)

(21) Appl. No.: 18/569,381

(22) PCT Filed: Jul. 20, 2022
(86) PCT No.: PCT/JP2022/028141

§ 371 Date: Dec. 12, 2023

(30) Foreign Application Priority Data
Jul. 30, 2021 (JP) 2021-125038

(51) Int. Cl. G01M 15/14; F01D 21/00; G08B 21/18

(52) U.S. Cl. CPC G01M 15/14; F01D 21/003; G08B 21/182; F05D 2260/80

(57) ABSTRACT

A plant monitoring device for monitoring a plant is provided with: a measured data acquisition unit which, for each prescribed period, acquires measured data of multiple variables indicating the state of the plant; a comparison unit which compares a diagnostic threshold value, and a deviation indicator value, which indicates the deviation between measured data and a reference dataset that relates to the aforementioned multiple variables; a reference data updating unit which updates the reference dataset; and an operation mode switching unit which switches the operation mode of the plant monitoring device between a monitoring mode, in which plant monitoring is performed on the basis of the comparison results by the comparison unit and a learning mode, in which at least the measured data for which the deviation indicator value is greater than the diagnostic threshold value is imported into the reference dataset by the reference data update unit.

### TECHNICAL FIELD

The present disclosure relates to a plant monitoring device, a plant monitoring method, and a plant monitoring program.

The present application claims priority based on Japanese Patent Application No. 2021-125038 filed in the Japan Patent Office on Jul. 30, 2021, the contents of which are incorporated herein by reference.

### BACKGROUND ART

Abnormality diagnosis of a plant may be performed on the basis of a deviation index value indicating a deviation between a data set for reference (reference data set) of variables indicating a state of the plant (for example, a state quantity that can be acquired by a sensor) and measured data for the variables.

PTL 1 discloses a technique that inputs measured data of a process acquired in a plant to a process monitoring model, calculates a statistic which is a statistical error index or a statistical variance index, and determines whether the process is normal or abnormal on the basis of the magnitude of the deviation of the statistic from a preset normal process state.

### CITATION LIST

### Patent Literature

[PTL 1] Japanese Unexamined Patent Application Publication No. 2009-70071

### SUMMARY OF INVENTION

### Technical Problem

However, in a case in which an abnormality occurs in the plant, the deviation index value indicating the deviation between the reference data set and the measured data is larger than that when the plant is normal. Therefore, it is possible to perform the abnormality diagnosis of the plant on the basis of the comparison between the deviation index value and a threshold value.

On the other hand, even in a case in which an abnormality does not actually occur in the plant, a value measured by the sensor may be different from a previous value due to, for example, a change in an operating state of the plant. Even in this case, the deviation index value calculated from the measured data is expected to increase, but an operation of the plant can be continued. Alternatively, even in a case in which an abnormality occurs in plant equipment and the deviation index value calculated from the measured data increases, it may be determined that the operation of the plant can be continued on the basis of, for example, past experience.

In a case in which the operation of the plant is continued when the deviation index value is large as described above, the magnitude of the deviation index value hardly changes even though another abnormality occurs in the plant thereafter, and it may be difficult to detect the abnormality of the plant.

In view of the above circumstances, an object of at least one embodiment of the present invention is to provide a plant monitoring device, a plant monitoring method, and a plant monitoring program that can perform a robust abnormality diagnosis.

### Solution to Problem

According to at least one embodiment of the present invention, there is provided a plant monitoring device for monitoring a plant. The plant monitoring device includes: a measured data acquisition unit configured to acquire measured data of a plurality of variables indicating a state of the plant every predetermined period; a comparison unit configured to compare a deviation index value indicating a deviation between a reference data set, which is a set of reference data related to the plurality of variables, and the measured data with a diagnostic threshold value for performing an abnormality diagnosis of the plant; a reference data update unit configured to update the reference data set; and an operation mode switching unit configured to switch an operation mode of the plant monitoring device between a monitoring mode, in which the plant is monitored on the basis of a comparison result by the comparison unit, and a learning mode, in which the reference data update unit incorporates, into the reference data set, at least the measured data when the deviation index value is greater than the diagnostic threshold value. The operation mode switching unit is configured to switch the operation mode from the monitoring mode to the learning mode when the deviation index value is greater than the diagnostic threshold value and a learning mode transition condition is satisfied during an operation of the plant monitoring device in the monitoring mode.

In addition, according to at least one embodiment of the present invention, there is provided a plant monitoring method using a plant monitoring device for monitoring a plant. The plant monitoring method includes: a step of acquiring measured data of a plurality of variables indicating a state of the plant every predetermined period; a comparison step of comparing a deviation index value indicating a deviation between a reference data set, which is a set of reference data related to the plurality of variables, and the measured data with a diagnostic threshold value for performing an abnormality diagnosis of the plant; a step of updating the reference data set; and an operation mode switching step of switching an operation mode of the plant monitoring device between a monitoring mode, in which the plant is monitored on the basis of a comparison result in the comparison step, and a learning mode, in which at least the measured data when the deviation index value is greater than the diagnostic threshold value is incorporated into the reference data set. In the operation mode switching step, the operation mode is switched from the monitoring mode to the learning mode when the deviation index value is greater than the diagnostic threshold value and a learning mode transition condition is satisfied during n operation of the plant monitoring device in the monitoring mode.

Further, according to at least one embodiment of the present invention, there is provided a plant monitoring program for operating a plant monitoring device for monitoring a plant. The plant monitoring program causes a computer to execute: a procedure of acquiring measured data of a plurality of variables indicating a state of the plant every predetermined period; a comparison procedure of comparing a deviation index value indicating a deviation between a reference data set, which is a set of reference data related to the plurality of variables, and the measured data with a diagnostic threshold value for performing an abnormality diagnosis of the plant; a procedure of updating the reference data set; and a procedure of switching an operation mode of the plant monitoring device between a monitoring mode, in which the plant is monitored on the basis of a comparison result in the comparison procedure, and a learning mode, in which at least the measured data when the deviation index value is greater than the diagnostic threshold value is incorporated into the reference data set. In the procedure of switching the operation mode, the operation mode is switched from the monitoring mode to the learning mode when the deviation index value is greater than the diagnostic threshold value and a learning mode transition condition is satisfied during an operation of the plant monitoring device in the monitoring mode.

### Advantageous Effects of Invention

According to at least one embodiment of the present invention, there are provided a plant monitoring device, a plant monitoring method, and a plant monitoring program that can perform a robust abnormality diagnosis.

### BRIEF DESCRIPTION OF DRAWINGS

FIG. 1 is a schematic configuration diagram illustrating an example of a plant to be monitored.

FIG. 2 is a schematic configuration diagram illustrating a plant monitoring device according to an embodiment.

FIG. 3 is a flowchart illustrating a plant monitoring method according to an embodiment.

FIG. 4 is a diagram illustrating the plant monitoring method according to the embodiment.

FIG. 5 is a diagram illustrating the plant monitoring method according to the embodiment.

FIG. 6 is a diagram illustrating an example of a list of determination conditions for determining a state of a plant.

FIG. 7 is a diagram schematically illustrating a unit space (reference data set) and an MD value (deviation index value).

FIG. 8 is a diagram schematically illustrating the unit space (reference data set) and the MD value (deviation index value).

### DESCRIPTION OF EMBODIMENTS

Hereinafter, some embodiments of the present invention will be described with reference to the accompanying drawings. However, dimensions, materials, shapes, relative dispositions, and the like of components described as embodiments or illustrated in the drawings are not intended to limit the scope of the present invention, but are only explanatory examples.

### (Example of Configuration of Plant to be Monitored)

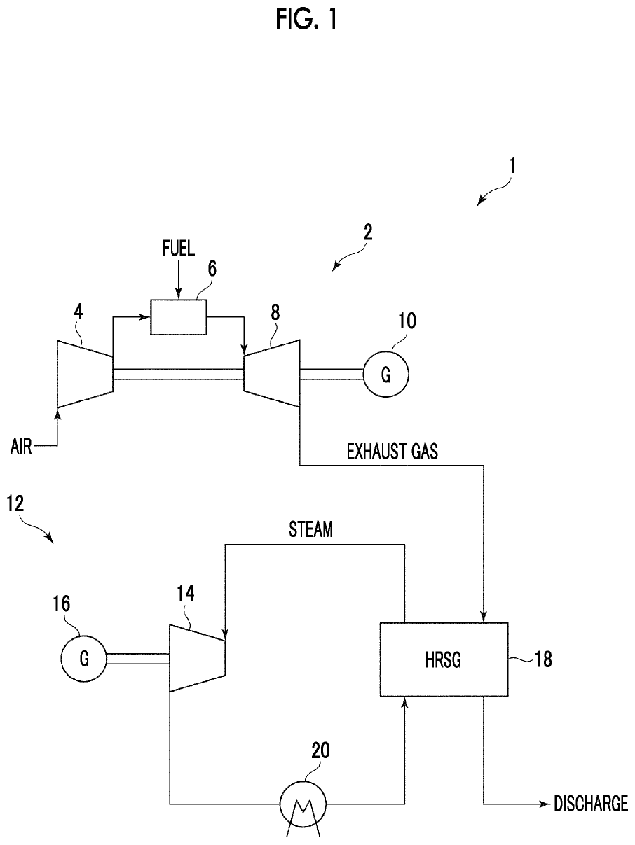

FIG. 1 is a schematic configuration diagram illustrating an example of a plant to which a plant monitoring device, a plant monitoring method, or a plant monitoring program according to some embodiments is applied. A plant 1 illustrated in FIG. 1 is a gas turbine combined cycle (GTCC) plant (combined cycle plant) including gas turbine equipment 2 (gas turbine), a heat recovery steam generator (HRSG) 18 (boiler), and steam turbine equipment 12 (steam turbine).

The gas turbine equipment 2 includes a compressor 4 for compressing air, a combustor 6 for combusting fuel together with the compressed air from the compressor 4, and a turbine 8 that is configured to be driven by combustion gas generated by the combustor 6. A generator 10 is connected to a rotor of the turbine 8. The generator 10 is rotationally driven by the turbine 8. The combustion gas whose work has been completed in the turbine 8 is discharged as exhaust gas from the turbine 8.

The heat recovery steam generator 18 is configured to generate steam using heat of the exhaust gas from the gas turbine equipment 2. The heat recovery steam generator 18 has an exhaust duct into which the exhaust gas is introduced from the gas turbine equipment 2 and a heat exchanger which is provided to pass through the inside of the exhaust duct. Condensate is introduced from a condenser 20 of the steam turbine equipment 12, which will be described below, into the heat exchanger. The heat exchanger generates steam using heat exchange between the condensate and the exhaust gas flowing through the exhaust duct. In addition, the exhaust gas that has flowed through the exhaust duct of the heat recovery steam generator 18 and that has passed through the heat exchanger may be discharged from, for example, a chimney (not illustrated).

The steam turbine equipment 12 illustrated in FIG. 1 includes a turbine 14 that is configured to be driven by the steam from the heat recovery steam generator 18. A generator 16 is connected to a rotor of the turbine 14. The generator 16 is rotationally driven by the turbine 14. The steam whose work has been completed in the turbine 14 is guided to the condenser 20, is condensed, returns to the heat recovery steam generator 18, and is heated again by heat exchange with the exhaust gas.

In some embodiments, the plant to be monitored may be the above-described combined cycle plant. In some embodiments, the plant to be monitored may be a plant including either a gas turbine or a steam turbine.

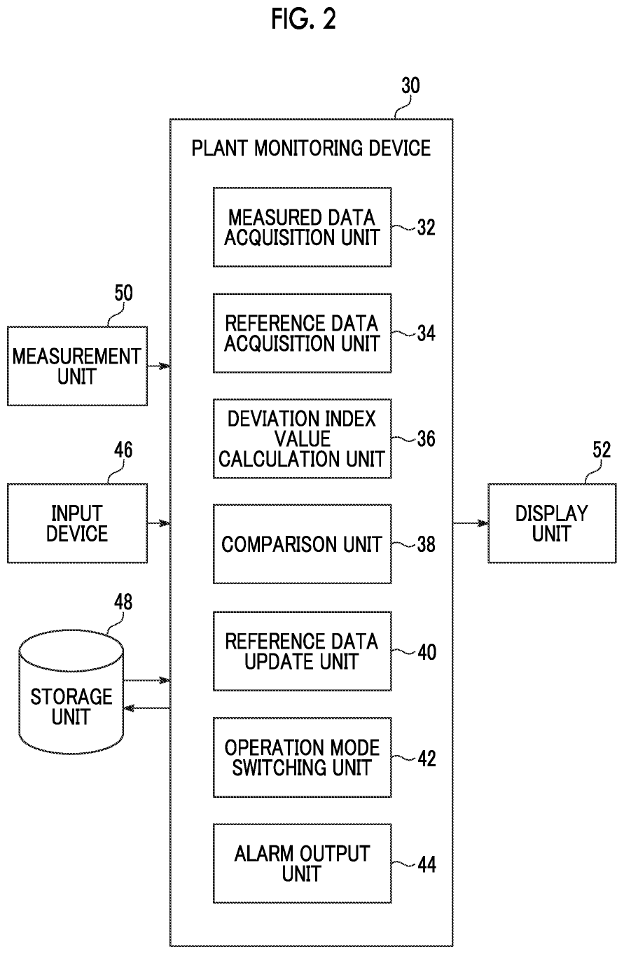

The plant 1 is provided with a measurement unit 50 (see FIG. 2) for measuring a plurality of variables indicating a state of the plant. The measurement unit 50 may include a plurality of sensors that are configured to measure the plurality of variables indicating the state of the plant 1, respectively.

In a case in which the plant 1 includes a gas turbine, the measurement unit 50 may include sensors that are configured to measure, as the variables indicating the state of the plant, any of a rotor rotation speed, a blade path temperature of each stage, a blade path average temperature, a turbine inlet pressure, a turbine outlet pressure, a generator output, and a differential pressure of an intake filter in the gas turbine. In a case in which the plant 1 is a combined cycle plant including a gas turbine and a steam turbine, the measurement unit 50 may include a sensor that is configured to measure the pressure of the exhaust duct (the exhaust duct into which the exhaust gas is introduced from the gas turbine equipment 2) of the heat recovery steam generator 18.

### (Configuration of Plant Monitoring Device)

FIG. 2 is a schematic configuration diagram illustrating a plant monitoring device according to an embodiment. A plant monitoring device 30 illustrated in FIG. 2 is configured to monitor the plant on the basis of measured values of the plurality of variables indicating the state of the plant measured by the measurement unit 50.

As illustrated in FIG. 2, the plant monitoring device 30 according to the embodiment includes a measured data acquisition unit 32, a reference data acquisition unit 34, a deviation index value calculation unit 36, a comparison unit 38, a reference data update unit 40, and an operation mode switching unit 42. The plant monitoring device 30 may include an alarm output unit 44.

The plant monitoring device 30 includes a computer having a processor (a CPU or the like), a main storage device (a memory device; a RAM or the like), an auxiliary storage device, an interface, and the like. The plant monitoring device 30 receives signals from the measurement unit 50, an input device 46 (a keyboard, a mouse, or the like), or a storage unit 48 through the interface. The processor is configured to process the received signals. In addition, the processor is configured to process a program deployed in the main storage device. In this way, the functions of each of the above-described functional units (the measured data acquisition unit 32 and the like) are implemented.

The content of the process in the plant monitoring device 30 is implemented as programs executed by the processor. The programs may be stored in, for example, the auxiliary storage device. When the programs are executed, these programs are deployed in the main storage device. The processor reads the program from the main storage device and executes a command included in the program.

In addition, the storage unit 48 may include the main storage device or the auxiliary storage device of the computer constituting the plant monitoring device 30. Alternatively, the storage unit 48 may include a remote storage device that is connected to the computer through a network.

The measured data acquisition unit 32 is configured to acquire measured data (a data set of a plurality of variables) of a plurality of variables (V1, V2, . . . , Vn) indicating the state of the plant every predetermined period (at a predetermined interval of time t1, t2, . . . ). The measured data acquisition unit 32 may acquire, as the measured data, a representative value (for example, an average value) of the measured values of the variables for a predetermined period based on each time (each of the times t1, t2, . . . ). The measured data acquisition unit 32 may be configured to store the measured data acquired every predetermined period in the storage unit 48.

In a case in which the plant to be monitored includes a gas turbine, the plurality of variables (V1, V2, . . . , Vn) indicating the state of the plant may include any of a rotor rotation speed, a blade path temperature of each stage, a blade path average temperature, a turbine inlet pressure, a turbine outlet pressure, a generator output, and a differential pressure of an intake filter in the gas turbine. In a case in which the plant to be monitored is a combined cycle plant including a gas turbine and a steam turbine, the plurality of variables (V1, V2, . . . , Vn) indicating the state of the plant may include the pressure of the exhaust duct of the heat recovery steam generator 18.

The reference data acquisition unit 34 acquires a reference data set which is a set of reference data (a data set of the plurality of variables) related to the plurality of variables. The reference data set is a set of data which indicates a reference state of the plant and is compared with the measured data to be evaluated (to be diagnosed) in abnormality diagnosis and is configured by, for example, the measured data acquired in the past. The reference data acquisition unit 34 may be configured to acquire the reference data set stored in the storage unit 48.

The deviation index value calculation unit 36 is configured to calculate a deviation index value indicating a deviation between the reference data set acquired by the reference data acquisition unit 34 and the measured data acquired by the measured data acquisition unit 32. The deviation index value indicates the degree of deviation of the measured data to be evaluated from the reference state of the plant, and the abnormality diagnosis and monitoring of the plant are performed on the basis of the deviation index value.

In a case in which the abnormality diagnosis is performed using a Mahalanobis-Taguchi method (MT method), the deviation index value calculation unit 36 calculates, as the deviation index value, a Mahalanobis distance (MD value) which is a distance of the measured data to be evaluated from the center of a unit space on the basis of the unit space configured by the reference data set. In addition, when the MD value is small, target data is highly likely to be normal. When the MD value is large, the target data is highly likely to be abnormal.

The comparison unit 38 is configured to compare the deviation index value calculated by the deviation index value calculation unit 36 with a diagnostic threshold value for performing the abnormality diagnosis of the plant. The diagnostic threshold value may be preset. Further, the diagnostic threshold value may be stored in the storage unit 48, and the comparison unit 38 may read the diagnostic threshold value from the storage unit 48.

In addition, the abnormality diagnosis of the plant by the plant monitoring device 30 may be performed on the basis of the result of the comparison unit 38. For example, in a case in which the deviation index value calculated from the measured data to be evaluated is greater than the diagnostic threshold value, the plant monitoring device 30 may determine that an abnormality has occurred in the plant or is likely to occur in the plant.

The reference data update unit 40 is configured to update the reference data set according to an operation mode (a monitoring mode or a learning mode) of the plant monitoring device, which will be described below. Updating the reference data set means incorporating newly acquired measured data of the plurality of variables into the reference data set (that is, treating the measured data as reference data constituting the reference data set). The reference data update unit 40 may be configured to determine whether or not to incorporate each measured data item acquired at each time (t1, t2, . . . ) into the reference data set.

When one measured data item of the plurality of variables is incorporated into the reference data set, the reference data update unit 40 may be configured to remove, from the reference data set, one of the reference data items (for example, past measured data items) constituting the reference data set.

The operation mode switching unit 42 is configured to switch the operation mode of the plant monitoring device 30 between the monitoring mode and the learning mode. Here, the monitoring mode is an operation mode in which the plant is monitored on the basis of the comparison result by the comparison unit 38. In addition, the learning mode is an operation mode in which the reference data update unit 40 incorporates, into the reference data set, at least the measured data when the deviation index value is greater than the diagnostic threshold value.

Further, in the monitoring mode, the reference data update unit 40 may incorporate, into the reference data set, the measured data when the deviation index value is equal to or less than the diagnostic threshold value.

When the deviation index value calculated by the deviation index value calculation unit 36 is greater than the diagnostic threshold value and a predetermined learning mode transition condition is satisfied during the operation of the plant monitoring device 30 in the monitoring mode, the operation mode switching unit 42 is configured to switch the operation mode of the plant monitoring device 30 from the monitoring mode to the learning mode.

The plant monitoring device 30 may include the alarm output unit 44 that is configured to output an alarm when the result of the comparison between the deviation index value and the diagnostic threshold value by the comparison unit 38 shows that the deviation index value is greater than the diagnostic threshold value.

In addition, the deviation index value calculated by the deviation index value calculation unit 36, the result of the comparison between the deviation index value and the diagnostic threshold value by the comparison unit 38 and/or a result of abnormality diagnosis based on the comparison result, or the alarm output by the alarm output unit 44 may be displayed on a display unit 52 (display or the like).

In general, in a case in which an abnormality occurs in the plant, the deviation index value indicating the deviation between the reference data set and the measured data is larger than that when the plant is normal. Therefore, it is possible to perform the abnormality diagnosis of the plant on the basis of the comparison between the deviation index value and a threshold value.

On the other hand, even in a case in which an abnormality does not actually occur in the plant, a value measured by the sensor may be different from a previous value due to, for example, a change in an operating state of the plant. Even in this case, it is expected that the deviation index value calculated from the measured data will increase.

In a case in which the operation of the plant is continued when the deviation index value is large as described above, the magnitude of the deviation index value hardly changes even though another abnormality occurs in the plant thereafter, and it may be difficult to detect the abnormality of the plant.

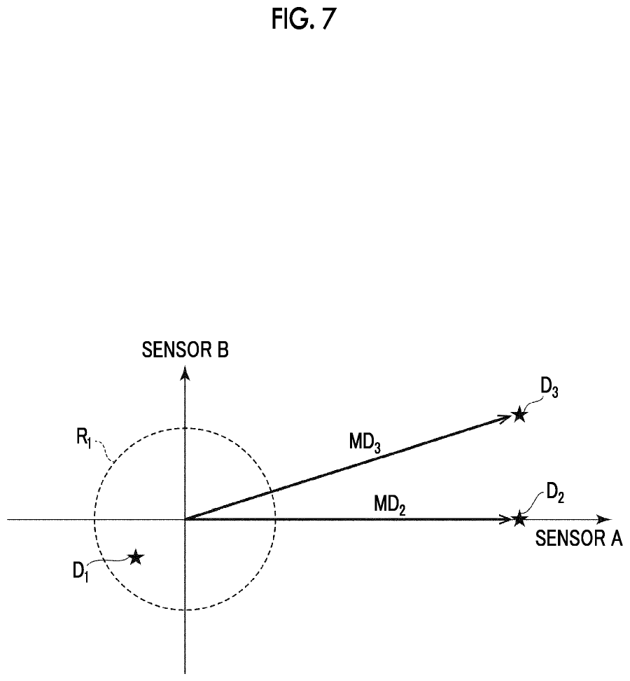

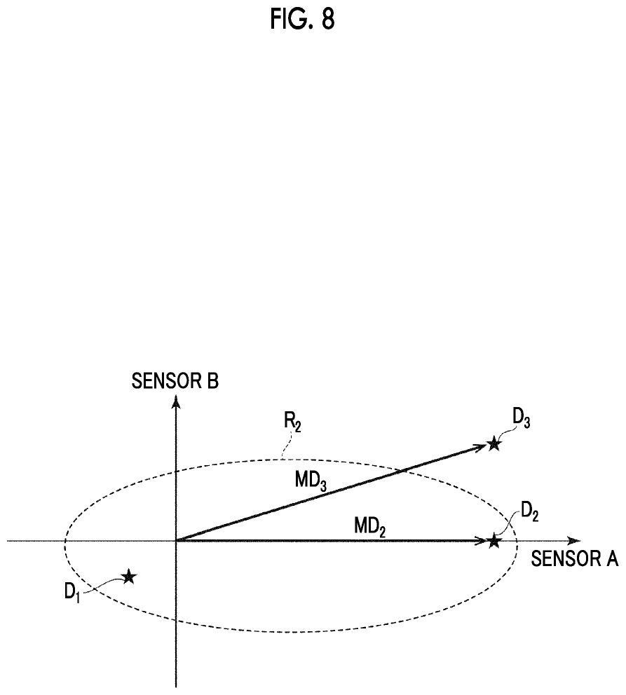

This will be described with reference to FIG. 7. Here, FIGS. 7 and 8 schematically illustrate a unit space (reference data set) created on the basis of the plurality of variables indicating the state of the plant and an MD value (deviation index value) calculated from the unit space and the measured data. In FIG. 7, a region R1 represented by a broken line is a set of points where the MD value calculated on the basis of the unit space is equal to the diagnostic threshold value, and the measured data (for example, D1) within the range of the region R1 is data that is evaluated to be normal. In addition, in FIGS. 7 and 8, for simplification, a unit space based on two variables (variables measured by a sensor A and a sensor B) is schematically illustrated.

Assuming that the measured data when a measured value of the sensor A deviates from the reference data set is D2, an MD value (the length of an arrow MD2) calculated for the measured data D2 is out of the range of the region R1 and is greater than the diagnostic threshold value (see FIG. 7). However, in a case in which the cause of the deviation of the measured value of the sensor A from the reference data set is not the abnormality of the plant, it should not be determined that an abnormality has occurred in the plant just because MD2 is greater than the diagnostic threshold value.

Here, in a case in which the result of investigation shows that there is no abnormality in the plant, but the measured value of another sensor (here, the sensor B) deviates from the reference data set thereafter, an MD value (the length of an arrow MD3) calculated for measured data D3 in this case is not significantly different from MD2 (see FIG. 7). Therefore, for example, when the diagnostic threshold value is changed depending on MD2, there is a possibility that an abnormality of the plant will not be detected even though an abnormality has occurred in the measured value of the sensor B.

In this regard, in the plant monitoring device 30 having the above-described configuration, in a case in which the deviation index value is greater than the diagnostic threshold value, but a predetermined learning mode transition condition is satisfied during the operation in the monitoring mode, the operation mode of the plant monitoring device 30 is switched to the learning mode, and the measured data when the deviation index value is greater than the diagnostic threshold value is incorporated into the reference data set. Here, the case in which the predetermined learning mode transition condition is satisfied is, for example, a case in which it can be determined that an abnormality occurs on the basis of the deviation index value and that the deviation index value is large due to a factor other than the abnormality of plant equipment or a case in which it can be determined that the operation of the plant can be continued even when there is an abnormality in the plant equipment. As described above, the reference data set is redefined by incorporating, into the reference data set, the measured data when the deviation index value is greater than the diagnostic threshold value during the operation in the learning mode.

In the example described with reference to FIG. 7, the measured data D2 can be incorporated into the reference data set by operating the plant monitoring device 30 in the learning mode. FIG. 8 illustrates a unit space configured by the redefined reference data set. That is, in FIG. 8, a region R2 represented by a broken line is a set of points where the MD value calculated on the basis of the unit space configured by the redefined reference data set (reference data set including the measured data D2) is equal to the diagnostic threshold value. In addition, the unit space (see FIG. 8) based on the redefined reference data set has a larger standard deviation (variation) than the unit space (see FIG. 7) before the redefinition. Since the MD value is calculated using the unit space (see FIG. 8) based on the redefined reference data set, the MD value of the measured data D2 when no abnormality actually occurs in the plant is equal to or less than the diagnostic threshold value (within the range of the region R2), and the MD value of the measured data D3 when an abnormality has occurred in the plant (or the sensor value) is greater than the diagnostic threshold value (out of the range of the region R2).

As described above, the abnormality diagnosis of the plant based on the redefined reference data set makes it possible to appropriately detect the abnormality of the plant. Therefore, according to the plant monitoring device 30 having the above-described configuration, it is possible to perform a robust abnormality diagnosis.

### (Plant Monitoring Flow)

Hereinafter, a plant monitoring method according to some embodiments will be described in more detail. Further, a case in which the plant 1 is monitored by the plant monitoring device 30 will be described below. However, in some embodiments, the plant monitoring method may be performed using another device, or a portion of the following procedure may be performed manually. In addition, a plant monitoring method using an MT method will be described below. However, the same description may also be applied to a case in which the plant is monitored using other statistical methods (statistical process control (SPC), multi-variate statistical process control (MSPC), or the like.

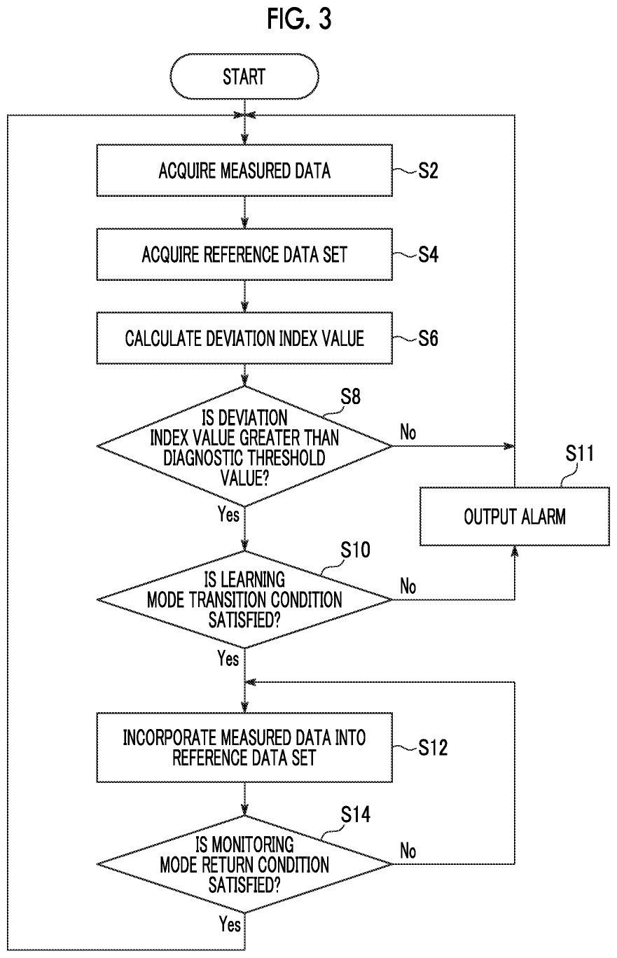

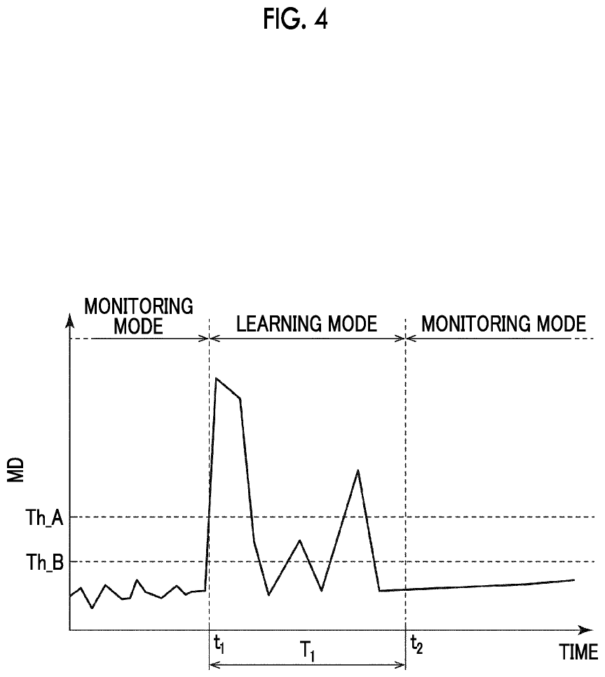

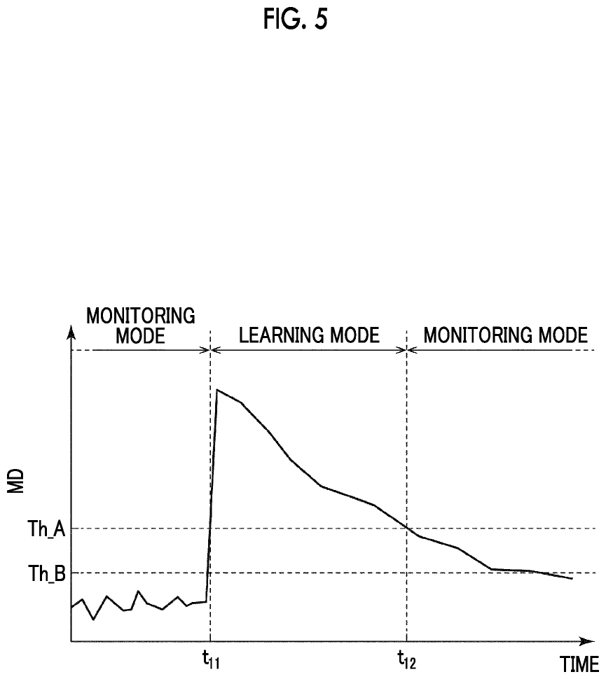

FIG. 3 is a flowchart illustrating the plant monitoring method according to some embodiments. FIGS. 4 and 5 are diagrams illustrating the plant monitoring method according to some embodiments and are graphs illustrating a change in the calculated deviation index value (specifically, the MD value; the vertical axis) over time.

Among steps in the flowchart illustrated in FIG. 3, Steps S2 to S11 are procedures when the plant monitoring device 30 is operating in the monitoring mode, and Steps S12 to S14 are procedures when the plant monitoring device 30 is operating in the learning mode.

In a plant monitoring method according to an embodiment, during the operation of the plant monitoring device 30 in the monitoring mode, first, the measured data acquisition unit 32 acquires the measured data (a data set of a plurality of variables) of the plurality of variables (V1, V2, . . . , Vn) indicating the state of the plant every predetermined period (at a predetermined interval of time t1, t2, . . . ) (S2).

In addition, the reference data acquisition unit 34 acquires the reference data set, which is a set of reference data (data set of a plurality of variables) related to the plurality of variables from, for example, the storage unit 48 (S4).

Then, the deviation index value calculation unit 36 calculates the deviation index value indicating the deviation between the reference data set acquired in Step S4 and the measured data acquired in Step S2 (S6). In this embodiment, in Step S6, the Mahalanobis distance (MD value), which is the distance of the measured data to be evaluated from the center of the unit space, is calculated as the deviation index value on the basis of the unit space configured by the reference data set.

Then, the comparison unit 38 compares the MD value (deviation index value) calculated in Step S6 with a diagnostic threshold value Th_A (see FIGS. 4 and 5) for the abnormality diagnosis of the plant 1 (S8). In addition, the plant monitoring device 30 may perform the abnormality diagnosis or monitoring of the plant 1 on the basis of the result of the comparison between the MD value (deviation index value) and the diagnostic threshold value Th_A in Step S8.

In a case in which the MD value (deviation index value) is equal to or less than the diagnostic threshold value Th_A in Step S8 (No in S8), it is determined that no abnormality has occurred in the plant 1. Therefore, the process returns to Step S2, and the operation in the monitoring mode is continued. Further, in this case, the reference data update unit 40 may incorporate the measured data (the measured data acquired in Step S2) for which the MD value (deviation index value) has been calculated in Step S6 into the reference data set to update the reference data set.

On the other hand, in a case in which the MD value (deviation index value) is greater than the diagnostic threshold value Th_A in Step S8 (Yes in S8), the operation mode switching unit 42 determines whether or not the learning mode transition condition is satisfied (S10).

In a case in which the learning mode transition condition is satisfied in Step S10 (Yes in S10; the time t1 in FIG. 4 or the time t11 in FIG. 5), the operation mode switching unit 42 switches the operation mode of the plant monitoring device 30 from the monitoring mode to the learning mode. That is, the process proceeds to the subsequent Step S12, and the reference data update unit 40 incorporates, into the reference data set, at least the measured data when the MD value (deviation index value) is greater than the diagnostic threshold value (S12).

On the other hand, in a case in which the learning mode transition condition is not satisfied in Step S10 (No in S10), the process returns to Step S2, and the operation in the monitoring mode is continued. Further, in this case, since the MD value (deviation index value) is greater than the diagnostic threshold value Th_A and there is a possibility that an abnormality will occur in the plant 1, the alarm output unit 44 may output an alarm (S11).

The learning mode transition condition may include that it is determined that the MD value (deviation index value) is greater than the diagnostic threshold value Th_A due to a factor other than the abnormality of the plant 1.

### Example 1 of Learning Mode Transition Condition

For example, the learning mode transition condition may include that it is determined that the operation of the plant 1 can be continued on the basis of a preset determination condition. In addition, the preset determination condition may be stored in the storage unit 48.

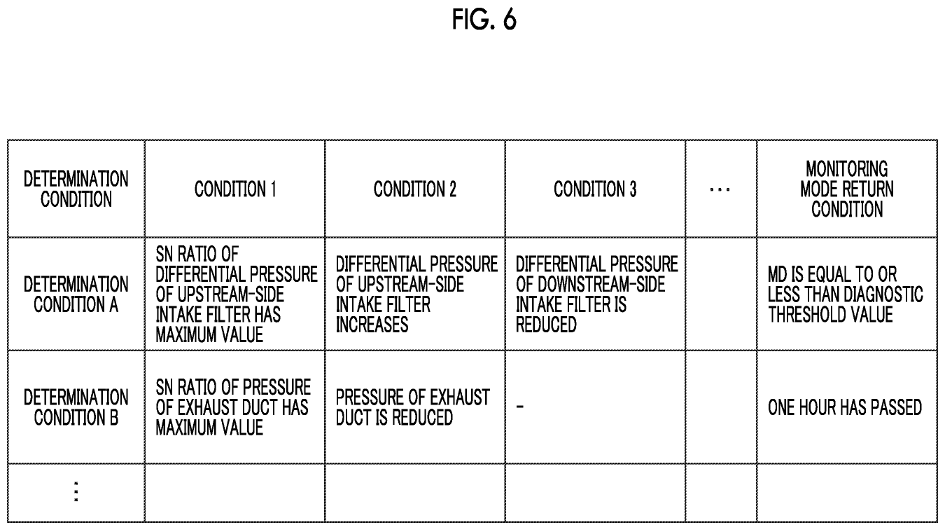

Whether or not the operation of the plant 1 can be continued may be determined on the basis of a list illustrated in FIG. 6. Here, FIG. 6 is a diagram illustrating an example of a list of determination conditions for determining whether or not the operation of the plant 1 can be continued. In the list illustrated in FIG. 6, the determination conditions (a determination condition A, a determination condition B, . . . ) are set for each row. In addition, in each column of the list illustrated in FIG. 6, individual conditions (condition 1, condition 2, . . . ) for each determination condition are set, and a monitoring mode return condition, which will be described below, is set. In the list illustrated in FIG. 6, when all of the individual conditions set in the row of the determination condition A are satisfied, it can be determined that the determination condition A is satisfied. In addition, when any one of the determination conditions (the determination condition A, the determination condition B, . . . ) set in each row is satisfied, it can be determined that the operation of the plant 1 can be continued.

More specifically, in the case of the plant 1 including a gas turbine, the determination condition may be the determination condition A (the first row in the list illustrated in FIG. 6) including that the main factor causing the MD value (deviation index value) to be greater than the diagnostic threshold value Th_A is an increase in the differential pressure of an intake filter of the gas turbine (conditions 1 and 2).

Further, the condition 1 of the determination condition A illustrated in FIG. 6 is that an SN ratio (a larger-the-better SN ratio in the MT method) of the differential pressure (sensor value) of an upstream-side intake filter provided in the gas turbine is the largest sensor value among the sensor values to be measured, and the condition 2 is that the differential pressure (sensor value) of the upstream-side intake filter is higher than normal (when the MD value (deviation index value) is equal to or less than the diagnostic threshold value Th_A). Further, the condition 3 is that the differential pressure of a downstream-side intake filter provided on a downstream side of the upstream-side intake filter in the gas turbine is lower than normal. In addition, in a case in which the SN ratio of a certain sensor value among the sensor values to be measured has the largest value, it can be determined that the sensor value is the main factor increasing the MD value.

In the plant 1 including the gas turbine, when it rains, the intake filter (in a case in which a plurality of intake filters are provided, an intake filter on an upstream side) of the gas turbine tends to be wet with rain, and the differential pressure before and after the intake filter tends to increase. Therefore, when the determination condition A is satisfied, the MD value (deviation index value) is greater than the diagnostic threshold value Th_A due to the rainy weather. Therefore, it is possible to determine that the operation of the plant 1 can be continued.

Alternatively, in a case in which the plant 1 is a combined cycle plant including a gas turbine and a steam turbine, the determination condition may be the determination condition B (second row in the list illustrated in FIG. 6) including that the main factor causing the MD value (deviation index value) to be greater than the diagnostic threshold value Th_A is a reduction in the pressure of the exhaust duct constituting the heat recovery steam generator 18 (conditions 1 and 2).

Further, the condition 1 of the determination condition B illustrated in FIG. 6 is that the SN ratio (larger-the-better SN ratio in the MT method) of the pressure (sensor value) of the exhaust duct constituting the heat recovery steam generator 18 has the largest value among the sensor values to be measured, and the condition 2 is that the pressure of the exhaust duct is lower than normal (when the MD value (deviation index value) is equal to or less than the diagnostic threshold value Th_A).

In the combined cycle plant including the gas turbine and the steam turbine, when the operation is switched from a combined cycle operation, in which the exhaust gas of the gas turbine is supplied to a boiler, to a simple cycle operation, in which the exhaust gas of the gas turbine is discharged to the outside without being supplied to the boiler, the pressure of an exhaust duct constituting the boiler is reduced. Therefore, when the determination condition B is satisfied, the MD value (deviation index value) is greater than the diagnostic threshold value Th_A by the switching of the operation mode of the combined cycle plant. As a result, it is possible to determine that the operation of the plant 1 can be continued.

### Example 2 of Learning Mode Transition Condition

Alternatively, the learning mode transition condition may include that the number of times the alarm output unit 44 outputs the alarm (that is, the number of times Step S11 is performed) exceeds a predetermined value.

In some cases, the fact that the alarm is repeatedly output because the MD value (deviation index value) is greater than the diagnostic threshold value Th_A indicates that an operator or the like determines that the operation of the plant 1 can be continued. Therefore, in a case in which the number of times the alarm output unit 44 outputs the alarm exceeds the predetermined value, it is possible to determine that the operation of the plant can be continued even when the MD value (deviation index value) is greater than the diagnostic threshold value Th_A.

### Example 3 of Learning Mode Transition Condition

Alternatively, the learning mode transition condition may include that the plant monitoring device 30 has received a command for switching the operation mode of the plant monitoring device 30 from the monitoring mode to the learning mode. In addition, for example, the command may be input from the input device 46 or the like by the operator or the like.

Even in a case in which the MD value (deviation index value) is greater than the diagnostic threshold value Th_A, the operator or the like may determine that the operation of the plant 1 can be continued. Therefore, when the plant monitoring device 30 receives the command for switching the operation mode to the learning mode, the operation mode of the plant monitoring device 30 may be switched to the learning mode.

As described above, in Step S12, among the data items acquired during the operation in the learning mode, at least the measured data when the MD value (deviation index value) calculated in Step S6 is greater than the diagnostic threshold value Th_A is incorporated into the reference data set.

In Step S12, among the measured data items acquired during the operation in the learning mode, the measured data when the MD value (deviation index value) calculated in Step S6 is greater than a learning threshold value Th_B (see FIGS. 4 and 5) may be incorporated into the reference data set. Here, the learning threshold value Th_B may be less than the diagnostic threshold value Th_A. The learning threshold value Th_B may be, for example, about half of the diagnostic threshold value Th_A.

This setting of the learning threshold value Th_B to be less than the diagnostic threshold value Th_A makes it possible to incorporate the measured data when the MD value is less than the diagnostic threshold value Th_A into the reference data set and to hold the reference data set even in a case in which the MD value (deviation index value) fluctuates in the vicinity of the diagnostic threshold value Th_A during the operation in the learning mode. Therefore, it is possible to suppress an erroneous warning and to stably operate the plant.

In Step S12, the frequency of incorporating the measured data into the reference data set during the operation in the learning mode may be higher than the frequency of incorporating the measured data into the reference data set during the operation in the monitoring mode (in the case of No in Step S8).

For example, in Step S12, among the measured data items acquired during the operation in the learning mode, all of the measured data items when the MD value (deviation index value) is greater than the learning threshold value Th_B may be incorporated into the reference data set. On the other hand, during the operation in the monitoring mode, the measured data may be incorporated into the reference data set, for example, at a ratio of one measured data item out of several tens to several hundreds of measured data items.

As described above, in the learning mode, the measured data is incorporated into the reference data at a higher frequency than in the monitoring mode. Therefore, it is possible to calculate the MD value (deviation index value) while more reliably reflecting a very small number of abnormal data items (measured data items when the MD value (deviation index value) is greater than the diagnostic threshold value Th_A) with respect to the total number of measured data items in the reference data set.

During the operation of the plant monitoring device in the learning mode, the operation mode switching unit 42 determines whether or not a condition for returning the operation mode from the learning mode to the monitoring mode (monitoring mode return condition) is satisfied (S14). In a case in which the monitoring mode return condition is not satisfied in Step S14 (No in S14), the process returns to Step S12, and the operation in the learning mode is continued. On the other hand, in a case in which the monitoring mode return condition is satisfied in Step S14 (Yes in S14), the operation mode switching unit 42 switches the operation mode of the plant monitoring device 30 from the learning mode to the monitoring mode. That is, the process returns to Step S2 and proceeds to the operation in the monitoring mode.

The monitoring mode return condition may include that a predetermined time has elapsed since the switching of the operation mode of the plant monitoring device 30 from the monitoring mode to the learning mode. For example, in the example illustrated in FIG. 4, it is determined that the monitoring mode return condition has been satisfied at a time t2 that is a predetermined time T1 after a time t1 when the operation mode of the plant monitoring device 30 was switched from the monitoring mode to the learning mode, and the operation mode of the plant monitoring device 30 is switched from the learning mode to the monitoring mode. In addition, as the monitoring mode return condition corresponding to the determination condition B (learning mode transition condition) illustrated in FIG. 6, one hour is set as the predetermined time. Further, the length of the predetermined time may be determined according to the content of the learning mode transition condition and may be, for example, a length between several minutes and several hours.

When the measured data when the MD value (deviation index value) is greater than the diagnostic threshold value Th_A is incorporated into the reference data set in the learning mode, a newly calculated deviation index value gradually decreases with the passage of time. In this regard, in the above-described embodiment, the operation mode is switched from the learning mode to the monitoring mode after a lapse of a predetermined time (T1) since the time (time t1) when the operation mode of the plant monitoring device 30 was switched to the learning mode. Therefore, the length of the predetermined time is set such that the MD value (deviation index value) calculated when the predetermined time (T1) elapses is sufficiently less than the diagnostic threshold value Th_A, which makes it possible to appropriately detect the abnormality of the plant 1 after the operation mode returns to the monitoring mode. As a result, it is possible to perform a robust abnormality diagnosis.

Alternatively, the monitoring mode return condition may include that the calculated MD value (deviation index value) is equal to or less than the diagnostic threshold value Th_A. For example, in the example illustrated in FIG. 5, it is determined that the monitoring mode return condition is satisfied at a time t12 after a time t11 when the operation mode of the plant monitoring device 30 was switched from the monitoring mode to the learning mode, and the operation mode of the plant monitoring device 30 is switched from the learning mode to the monitoring mode. In addition, as the monitoring mode return condition corresponding to the determination condition A (learning mode transition condition) illustrated in FIG. 6, a condition that the MD is equal to or less than the diagnostic threshold value is set.

When the measured data when the MD value (deviation index value) is greater than the diagnostic threshold value Th_A is incorporated into the reference data set in the learning mode, a newly calculated deviation index value gradually decreases with the passage of time. In this regard, in the above-described embodiment, when the MD value (deviation index value) is equal to or less than the diagnostic threshold value Th_A during the operation of the plant monitoring device 30 in the learning mode, the operation mode is switched from the learning mode to the monitoring mode. Therefore, it is possible to appropriately detect the abnormality of the plant 1 after the operation mode returns to the monitoring mode. As a result, it is possible to perform a robust abnormality diagnosis.

In some embodiments, during the operation in the monitoring mode or the learning mode, when one measured data item of the plurality of variables is incorporated into the reference data set (in the case of No in Step S8 or Step S12), the reference data update unit 40 may be configured to remove, from the reference data set, one of the reference data items (for example, the past measured data items) constituting the reference data set. Here, among the reference data items included in the reference data set, the measured data incorporated during the operation in the learning mode (Step S12) may be removed preferentially over the measured data incorporated during the operation in the monitoring mode (in the case of No in Step S8).

As described above, when one measured data item is newly incorporated into the reference data set, one measured data item is removed from the reference data set. Therefore, it is possible to maintain a calculation load for calculating the MD value (deviation index value) without increasing the calculation load and to make the reference data set correspond to the latest state of the plant.

In addition, the change in the operating state of the plant which can cause an increase in the MD value (deviation index value) may return to the original state some time later. For example, it is considered that an event in which the differential pressure of the intake filter of the gas turbine increases due to rainy weather returns to the original differential pressure when the rain stops. Therefore, as described above, among the reference data items included in the reference data set, the measured data incorporated during the operation in the learning mode is removed preferentially over the measured data incorporated during the operation in the monitoring mode, which makes it easy to redefine the reference data set in which the current operating state of the plant has been reflected. Therefore, it is possible to more appropriately perform the abnormality diagnosis of the plant 1.

For example, the content described in each of the above-described embodiments is understood as follows.
(1) According to at least one embodiment of the present invention, there is provided a plant monitoring device (30) for monitoring a plant (1). The plant monitoring device includes: a measured data acquisition unit (32) configured to acquire measured data of a plurality of variables indicating a state of the plant every predetermined period; a comparison unit (38) configured to compare a deviation index value indicating a deviation between a reference data set, which is a set of reference data related to the plurality of variables, and the measured data with a diagnostic threshold value for performing an abnormality diagnosis of the plant; a reference data update unit (40) configured to update the reference data set; and an operation mode switching unit (42) configured to switch an operation mode of the plant monitoring device between a monitoring mode, in which the plant is monitored on the basis of a comparison result by the comparison unit, and a learning mode, in which the reference data update unit incorporates, into the reference data set, at least the measured data when the deviation index value is greater than the diagnostic threshold value. The operation mode switching unit is configured to switch the operation mode from the monitoring mode to the learning mode when the deviation index value is greater than the diagnostic threshold value and a learning mode transition condition is satisfied during an operation of the plant monitoring device in the monitoring mode.

In the configuration according to (1), in a case in which the deviation index value is greater than the diagnostic threshold value, but a predetermined learning mode transition condition is satisfied during the operation of the plant monitoring device in the monitoring mode, the operation mode of the monitoring device is switched to the learning mode, and the measured data when the deviation index value is greater than the diagnostic threshold value is incorporated into the reference data set. Here, the case in which the predetermined learning mode transition condition is satisfied is, for example, a case in which it can be determined that an abnormality occurs on the basis of the deviation index value and that the deviation index value is large due to a factor other than the abnormality of plant equipment or a case in which it can be determined that the operation of the plant can be continued even when there is an abnormality in the plant equipment. As described above, the reference data set is redefined by incorporating, into the reference data set, the measured data when the deviation index value is greater than the diagnostic threshold value during the operation in the learning mode. Therefore, the abnormality of the plant can be appropriately detected by performing the abnormality diagnosis of the plant on the basis of the redefined reference data set. As a result, according to the configuration of (1), it is possible to perform a robust abnormality diagnosis.
(2) In some embodiments, in the configuration according to (1), the learning mode transition condition includes that it is determined that the deviation index value is greater than the diagnostic threshold value due to a factor other than an abnormality of the plant or that it is determined that an operation of the plant can be continued.

In the configuration according to (2), during the operation of the plant monitoring device in the monitoring mode, the operation mode of the plant monitoring device is switched to the learning mode when it is determined that the deviation index value is greater than the diagnostic threshold value due to a factor (for example, a change in the operating state of the plant) other than the abnormality of the plant or when it is determined that the operation of the plant can be continued even though there is an abnormality in the plant. Therefore, the abnormality of the plant can be appropriately detected by performing the abnormality diagnosis of the plant on the basis of the reference data set redefined in the learning mode. As a result, it is possible to perform a robust abnormality diagnosis.
(3) In some embodiments, in the configuration according to (1) or (2), the learning mode transition condition includes that it is determined that an operation of the plant can be continued on the basis of a preset determination condition.

According to the configuration of (3), the operation mode of the plant monitoring device is switched to the learning mode when the deviation index value is greater than the diagnostic threshold value, but it is determined that the operation of the plant can be continued on the basis of the preset determination condition during the operation of the plant monitoring device in the monitoring mode. Therefore, the abnormality of the plant can be appropriately detected by performing the abnormality diagnosis of the plant on the basis of the reference data set redefined in the learning mode. As a result, it is possible to perform a robust abnormality diagnosis.
(4) In some embodiments, in the configuration according to (3), the plant includes a gas turbine (for example, the gas turbine equipment 2), and the determination condition includes that a main factor causing the deviation index value to be greater than the diagnostic threshold value is an increase in a differential pressure of an intake filter of the gas turbine.

In the plant including the gas turbine, when it rains, the intake filter of the gas turbine tends to be wet with rain, and the differential pressure before and after the intake filter tends to increase. According to the configuration of (4), in a case in which the determination condition including that the main factor causing the deviation index value to be greater than the diagnostic threshold value is the increase in the differential pressure of the intake filter of the gas turbine is satisfied, it is determined that the operation of the plant can be continued because the deviation index value is greater than the diagnostic threshold value due to rainy weather, and the operation mode of the plant monitoring device is switched to the learning mode. Therefore, the abnormality of the plant can be appropriately detected by performing the abnormality diagnosis of the plant on the basis of the reference data set redefined in the learning mode. As a result, it is possible to perform a robust abnormality diagnosis.
(5) In some embodiments, in the configuration according to (3), the plant is a combined cycle plant including a gas turbine (for example, the gas turbine equipment 2) and a steam turbine (for example, the steam turbine equipment 12), and the determination condition includes that a main factor causing the deviation index value to be greater than the diagnostic threshold value is a reduction in pressure of an exhaust duct which constitutes a boiler (for example, the heat recovery steam generator 18) for generating steam to be supplied to the steam turbine and which is configured to supply an exhaust gas from the gas turbine.

In the combined cycle plant including the gas turbine and the steam turbine, when the operation is switched from a combined cycle operation, in which the exhaust gas of the gas turbine is supplied to a boiler, to a simple cycle operation, in which the exhaust gas of the gas turbine is discharged to the outside without being supplied to the boiler, the pressure of an exhaust duct constituting the boiler is reduced. According to the configuration of (5), in a case in which the determination condition including that the main factor causing the deviation index value to be greater than the diagnostic threshold value is the reduction in the pressure of the exhaust duct is satisfied, the deviation index value is greater than the diagnostic threshold value due to the switching of the operation mode of the combined cycle plant. Therefore, it is determined that the operation of the plant can be continued, and the operation mode of the plant monitoring device is switched to the learning mode. Therefore, the abnormality of the plant can be appropriately detected by performing the abnormality diagnosis of the plant on the basis of the reference data set redefined in the learning mode. As a result, it is possible to perform a robust abnormality diagnosis.
(6) In some embodiments, in the configuration according to (1) or (2), the plant monitoring device includes an alarm output unit (44) configured to output an alarm when the deviation index value is greater than the diagnostic threshold value during the operation of the plant monitoring device in the monitoring mode, and the learning mode transition condition includes that the number of times the alarm output unit outputs the alarm exceeds a predetermined value.

The fact that the alarm is repeatedly output because the deviation index value is greater than the diagnostic threshold value may indicate that the operator or the like determines that the operation of the plant can be continued. According to the configuration of (6), when the deviation index value is greater than the diagnostic threshold value and the number of times the alarm output unit outputs the alarm exceeds the predetermined value during the operation of the plant monitoring device in the monitoring mode, it is determined that the operation of the plant can be continued, and the operation mode of the plant monitoring device is switched to the learning mode. Therefore, the abnormality of the plant can be appropriately detected by performing the abnormality diagnosis of the plant on the basis of the reference data set redefined in the learning mode. As a result, it is possible to perform a robust abnormality diagnosis.
(7) In some embodiments, in the configuration according to (1), the learning mode transition condition includes that the plant monitoring device receives a command for switching the operation mode to the learning mode.

Even in a case in which the deviation index value is greater than the diagnostic threshold value, the operator or the like may determine that the operation of the plant can be continued. According to the configuration of (7), when the plant monitoring device receives the command for switching the operation mode to the learning mode which has been input by the operator or the like, the operation mode of the plant monitoring device is switched to the learning mode. Therefore, the abnormality of the plant can be appropriately detected by performing the abnormality diagnosis of the plant on the basis of the reference data set redefined in the learning mode. As a result, it is possible to perform a robust abnormality diagnosis.
(8) In some embodiments, in the configuration according to any one of (1) to (7), the operation mode switching unit is configured to switch the operation mode from the learning mode to the monitoring mode during an operation of the plant monitoring device in the learning mode after the lapse of a predetermined time since the switching of the operation mode from the monitoring mode to the learning mode.

In a case in which the measured data when the deviation index value is greater than the diagnostic threshold value is incorporated into the reference data set in the learning mode, a newly calculated deviation index value gradually decreases with the passage of time. In this regard, according to the configuration of (8), after the lapse of the predetermined time since the switching of the operation mode of the plant monitoring device to the learning mode, the operation mode is switched from the learning mode to the monitoring mode. Therefore, after the operation mode returns to the monitoring mode, the abnormality of the plant can be appropriately detected by setting the length of the predetermined time such that the deviation index value calculated when the predetermined time elapses is sufficiently less than the diagnostic threshold value. As a result, it is possible to perform a robust abnormality diagnosis.
(9) In some embodiments, in the configuration according to any one of (1) to (7), the operation mode switching unit is configured to switch the operation mode from the learning mode to the monitoring mode when the deviation index value is equal to or less than the diagnostic threshold value during an operation of the plant monitoring device in the learning mode.

In a case in which the measured data when the deviation index value is greater than the diagnostic threshold value is incorporated into the reference data set in the learning mode, a newly calculated deviation index value gradually decreases with the passage of time. In this regard, according to the configuration of (9), the operation mode is switched from the learning mode to the monitoring mode when the deviation index value is equal to or less than the diagnostic threshold value during the operation of the plant monitoring device in the learning mode. Therefore, it is possible to appropriately detect the abnormality of the plant after the operation mode returns to the monitoring mode. As a result, it is possible to perform a robust abnormality diagnosis.
(10) In some embodiments, in the configuration according to any one of (1) to (9), the reference data update unit is configured to incorporate, into the reference data set, the measured data when the deviation index value is equal to or less than the diagnostic threshold value during the operation in the monitoring mode.

According to the configuration of (10), the measured data when the deviation index value is equal to or less than the diagnostic threshold value is incorporated into the reference data set during the operation in the monitoring mode, and the measured data when the deviation index value is greater than the diagnostic threshold value is incorporated into the reference data set during the operation in the learning mode. That is, the measured data when the deviation index value is greater than the diagnostic threshold value in the learning mode is incorporated into the reference data set mainly composed of the measured data when the plant is normal in the monitoring mode to redefine the reference data. Therefore, the abnormality of the plant can be appropriately detected by performing the abnormality diagnosis of the plant on the basis of the redefined reference data set. As a result, it is possible to perform a robust abnormality diagnosis.
(11) In some embodiments, in the configuration according to any one of (1) to (10), in the learning mode, the reference data update unit is configured to incorporate the measured data into the reference data set at a higher frequency than in the monitoring mode.

According to the configuration of (11), in the learning mode, the measured data is incorporated into the reference data at a higher frequency than in the monitoring mode. Therefore, it is possible to calculate the deviation index value while more reliably reflecting, in the reference data, a very small number of abnormal data items (measured data items when the deviation index value is greater than the diagnostic threshold value) with respect to the total number of measured data items. Therefore, since the abnormality diagnosis of the plant is performed on the basis of the deviation index value calculated in this way, it is possible to perform a robust abnormality diagnosis of the plant.
(12) In some embodiments, in the configuration according to any one of (1) to (11), when one measured data item is incorporated into the reference data set, the reference data update unit is configured to remove, among the reference data items included in the reference data set, one of the reference data items included in the reference data set from the reference data set and is configured to preferentially remove the measured data incorporated during an operation in the learning mode over the measured data incorporated during the operation in the monitoring mode.

According to the configuration of (12), when one measured data item is newly incorporated into the reference data set, one measured data item is removed from the reference data set. Therefore, it is possible to maintain a calculation load for calculating the deviation index value without increasing the calculation load and to make the reference data set correspond to the latest state of the plant. In addition, among the reference data items included in the reference data set, the measured data incorporated during the operation in the learning mode is removed preferentially over the measured data incorporated during the operation in the monitoring mode. Therefore, it is easy to redefine the reference data set in which the current operating state of the plant has been reflected. Therefore, it is possible to more appropriately perform the abnormality diagnosis of the plant.
(13) In some embodiments, in the configuration according to any one of (1) to (12), the deviation index value is a Mahalanobis distance with respect to the measured data calculated on the basis of a unit space configured by the reference data set.

According to the configuration of (13), it is possible to appropriately perform the abnormality diagnosis of the plant on the basis of the Mahalanobis distance indicating the deviation between the unit space configured by the reference data set and the measured data.
(14) According to at least one embodiment of the present invention, there is provided a plant monitoring method using a plant monitoring device (30) for monitoring a plant. The plant monitoring method includes: a step (S2) of acquiring measured data of a plurality of variables indicating a state of the plant every predetermined period; a comparison step (S8) of comparing a deviation index value indicating a deviation between a reference data set, which is a set of reference data related to the plurality of variables, and the measured data with a diagnostic threshold value for performing an abnormality diagnosis of the plant; a step (S12) of updating the reference data set; and an operation mode switching step (S10) of switching an operation mode of the plant monitoring device between a monitoring mode, in which the plant is monitored on the basis of a comparison result in the comparison step, and a learning mode, in which at least the measured data when the deviation index value is greater than the diagnostic threshold value is incorporated into the reference data set. In the operation mode switching step, the operation mode is switched from the monitoring mode to the learning mode when the deviation index value is greater than the diagnostic threshold value and a learning mode transition condition is satisfied during an operation of the plant monitoring device in the monitoring mode.

In the method according to (14), in a case in which the deviation index value is greater than the diagnostic threshold value, but a predetermined learning mode transition condition is satisfied during the operation of the plant monitoring device in the monitoring mode, the operation mode of the monitoring device is switched to the learning mode, and the measured data when the deviation index value is greater than the diagnostic threshold value is incorporated into the reference data set. Here, the case in which the predetermined learning mode transition condition is satisfied is, for example, a case in which it can be determined that an abnormality occurs on the basis of the deviation index value and that the deviation index value is large due to a factor other than the abnormality of plant equipment or a case in which it can be determined that the operation of the plant can be continued even when there is an abnormality in the plant equipment. As described above, the reference data set is redefined by incorporating, into the reference data set, the measured data when the deviation index value is greater than the diagnostic threshold value during the operation in the learning mode. Therefore, the abnormality of the plant can be appropriately detected by performing the abnormality diagnosis of the plant on the basis of the redefined reference data set. As a result, according to the method of (14), it is possible to perform a robust abnormality diagnosis.
(15) According to at least one embodiment of the present invention, there is provided a plant monitoring program for operating a plant monitoring device (30) for monitoring a plant. The plant monitoring program causes a computer to execute: a procedure of acquiring measured data of a plurality of variables indicating a state of the plant every predetermined period; a comparison procedure of comparing a deviation index value indicating a deviation between a reference data set, which is a set of reference data related to the plurality of variables, and the measured data with a diagnostic threshold value for performing an abnormality diagnosis of the plant; a procedure of updating the reference data set; and a procedure of switching an operation mode of the plant monitoring device between a monitoring mode, in which the plant is monitored on the basis of a comparison result in the comparison procedure, and a learning mode, in which at least the measured data when the deviation index value is greater than the diagnostic threshold value is incorporated into the reference data set. In the procedure of switching the operation mode, the operation mode is switched from the monitoring mode to the learning mode when the deviation index value is greater than the diagnostic threshold value and a learning mode transition condition is satisfied during an operation of the plant monitoring device in the monitoring mode.

In the program according to (15), in a case in which the deviation index value is greater than the diagnostic threshold value, but a predetermined learning mode transition condition is satisfied during the operation of the plant monitoring device in the monitoring mode, the operation mode of the monitoring device is switched to the learning mode, and the measured data when the deviation index value is greater than the diagnostic threshold value is incorporated into the reference data set. Here, the case in which the predetermined learning mode transition condition is satisfied is, for example, a case in which it can be determined that an abnormality occurs on the basis of the deviation index value and that the deviation index value is large due to a factor other than the abnormality of plant equipment or a case in which it can be determined that the operation of the plant can be continued even when there is an abnormality in the plant equipment. As described above, during the operation in the learning mode, the measured data when the deviation index value is greater than the diagnostic threshold value is incorporated into the reference data set to redefine the reference data set corresponding to the operating state of the plant. Therefore, the abnormality of the plant can be appropriately detected by performing the abnormality diagnosis of the plant on the basis of the redefined reference data set. As a result, according to the program of (15), it is possible to perform a robust abnormality diagnosis.

The embodiments of the present invention have been described above. However, the present invention is not limited to the above-described embodiments and also includes modifications of the above-described embodiments and appropriate combinations of these embodiments.

In this specification, an expression representing a relative or absolute disposition, such as “in a certain direction”, “along a certain direction”, “parallel”, “orthogonal”, “center”, “concentric”, or “coaxial” does not strictly represent only the disposition, but also represents a state of being relatively displaced with a tolerance or a sufficient angle or distance to obtain the same function. For example, expressions, such as “identical”, “equal”, and “homogeneous”, representing that things are in an equal state do not strictly represent only the equal state, but also represent a state in which there is a tolerance or a sufficient difference to obtain the same function.

In addition, in this specification, an expression representing a shape, such as a quadrangular shape or a cylindrical shape, does not strictly represent only a shape, such as a quadrangular shape or a cylindrical shape, in a strictly geometric sense, but also represents a shape including an undulating portion, a chamfered portion, or the like within a range in which the same effect is obtained.

In addition, in this specification, an expression, such as “comprising”, “including”, or “having” one component, is not an exclusive expression excluding the presence of other components.

### REFERENCE SIGNS LIST

1: Plant
2: Gas turbine equipment
4: Compressor
6: Combustor
8: Turbine
10: Generator
12: Steam turbine equipment
14: Turbine
16: Generator
18: Heat recovery steam generator
20: Condenser
30: Plant monitoring device
32: Measured data acquisition unit
34: Reference data acquisition unit
36: Deviation index value calculation unit
38: Comparison unit
40: Reference data update unit
42: Operation mode switching unit
44: Alarm output unit
46: Input device
48: Storage unit
50: Measurement unit
52: Display unit

1. A plant monitoring device for monitoring a plant, the plant monitoring device comprising:
a measured data acquisition unit configured to acquire measured data of a plurality of variables indicating a state of the plant every predetermined period;
a comparison unit configured to compare a deviation index value indicating a deviation between a reference data set, which is a set of reference data related to the plurality of variables, and the measured data with a diagnostic threshold value for performing an abnormality diagnosis of the plant;
a reference data update unit configured to update the reference data set; and
an operation mode switching unit configured to switch an operation mode of the plant monitoring device between a monitoring mode, in which the plant is monitored on the basis of a comparison result by the comparison unit, and a learning mode, in which the reference data update unit incorporates, into the reference data set, at least the measured data when the deviation index value is greater than the diagnostic threshold value,
wherein the operation mode switching unit is configured to switch the operation mode from the monitoring mode to the learning mode when the deviation index value is greater than the diagnostic threshold value and a learning mode transition condition is satisfied during an operation of the plant monitoring device in the monitoring mode.

2. The plant monitoring device according to claim 1,
wherein the learning mode transition condition includes that it is determined that the deviation index value is greater than the diagnostic threshold value due to a factor other than an abnormality of the plant or that it is determined that an operation of the plant is capable of being continued.

3. The plant monitoring device according to claim 1,
wherein the learning mode transition condition includes that it is determined that an operation of the plant is capable of being continued on the basis of a preset determination condition.

4. The plant monitoring device according to claim 3,
wherein the plant includes a gas turbine, and
the determination condition includes that a main factor causing the deviation index value to be greater than the diagnostic threshold value is an increase in a differential pressure of an intake filter of the gas turbine.

5. The plant monitoring device according to claim 3,
wherein the plant is a combined cycle plant including a gas turbine and a steam turbine, and
the determination condition includes that a main factor causing the deviation index value to be greater than the diagnostic threshold value is a reduction in pressure of an exhaust duct which constitutes a boiler for generating steam to be supplied to the steam turbine and which is configured to supply an exhaust gas from the gas turbine.

6. The plant monitoring device according to claim 1, further comprising:
an alarm output unit configured to output an alarm when the deviation index value is greater than the diagnostic threshold value during the operation of the plant monitoring device in the monitoring mode,
wherein the learning mode transition condition includes that the number of times the alarm output unit outputs the alarm exceeds a predetermined value.

7. The plant monitoring device according to claim 1,
wherein the learning mode transition condition includes that the plant monitoring device receives a command for switching the operation mode to the learning mode.

8. The plant monitoring device according to claim 1,
wherein the operation mode switching unit is configured to switch the operation mode from the learning mode to the monitoring mode during an operation of the plant monitoring device in the learning mode after a lapse of a predetermined time since the switching of the operation mode from the monitoring mode to the learning mode.

9. The plant monitoring device according to claim 1,
wherein the operation mode switching unit is configured to switch the operation mode from the learning mode to the monitoring mode when the deviation index value is equal to or less than the diagnostic threshold value during an operation of the plant monitoring device in the learning mode.

10. The plant monitoring device according to claim 1,
wherein the reference data update unit is configured to incorporate, into the reference data set, the measured data when the deviation index value is equal to or less than the diagnostic threshold value during the operation in the monitoring mode.

11. The plant monitoring device according to claim 1,
wherein, in the learning mode, the reference data update unit is configured to incorporate the measured data into the reference data set at a higher frequency than in the monitoring mode.

12. The plant monitoring device according to claim 1,
wherein, when one measured data item is incorporated into the reference data set, the reference data update unit is configured to remove, among the reference data items included in the reference data set, one of the reference data items included in the reference data set from the reference data set and is configured to preferentially remove the measured data incorporated during an operation in the learning mode over the measured data incorporated during the operation in the monitoring mode.

13. The plant monitoring device according to claim 1,
wherein the deviation index value is a Mahalanobis distance with respect to the measured data calculated on the basis of a unit space configured by the reference data set.

14. A plant monitoring method using a plant monitoring device for monitoring a plant, the plant monitoring method comprising:
a step of acquiring measured data of a plurality of variables indicating a state of the plant every predetermined period;
a comparison step of comparing a deviation index value indicating a deviation between a reference data set, which is a set of reference data related to the plurality of variables, and the measured data with a diagnostic threshold value for performing an abnormality diagnosis of the plant;
a step of updating the reference data set; and
an operation mode switching step of switching an operation mode of the plant monitoring device between a monitoring mode, in which the plant is monitored on the basis of a comparison result in the comparison step, and a learning mode, in which at least the measured data when the deviation index value is greater than the diagnostic threshold value is incorporated into the reference data set,
wherein, in the operation mode switching step, the operation mode is switched from the monitoring mode to the learning mode when the deviation index value is greater than the diagnostic threshold value and a learning mode transition condition is satisfied during an operation of the plant monitoring device in the monitoring mode.

15. A plant monitoring program for operating a plant monitoring device for monitoring a plant, the plant monitoring program causing a computer to execute:
a procedure of acquiring measured data of a plurality of variables indicating a state of the plant every predetermined period;
a comparison procedure of comparing a deviation index value indicating a deviation between a reference data set, which is a set of reference data related to the plurality of variables, and the measured data with a diagnostic threshold value for performing an abnormality diagnosis of the plant;
a procedure of updating the reference data set; and
a procedure of switching an operation mode of the plant monitoring device between a monitoring mode, in which the plant is monitored on the basis of a comparison result in the comparison procedure, and a learning mode, in which at least the measured data when the deviation index value is greater than the diagnostic threshold value is incorporated into the reference data set,
wherein, in the procedure of switching the operation mode, the operation mode is switched from the monitoring mode to the learning mode when the deviation index value is greater than the diagnostic threshold value and a learning mode transition condition is satisfied during an operation of the plant monitoring device in the monitoring mode.
